(19) United States
(12) Patent Application Publication
(10) Pub. No.: US 2002/0010691 A1
(43) Pub. Date: Jan. 24, 2002

(54) Apparatus and method for fuzzy analysis of statistical evidence

(76) Inventor: Yuan Yan Chen, Woodbridge, VA (US)

Correspondence Address: Christian C. Michel, Roylance, Abrams, Berdo & Goodman, L.L.P., 1300 19th Street, N.W., Suite 600, Washington, DC, 20036, US

(21) Appl. No.: 09/808,101

(22) Filed: Mar. 15, 2001

Related U.S. Application Data
(60) Provisional application No. 60/189,893, filed on Mar. 16, 2000.

(51) Int. Cl. G06F 15/18

(52) U.S. Cl. 706/20

(57) ABSTRACT

An apparatus and method for performing parallel distributed processing are disclosed. A plurality of nodes are connected with weight connections. The weight connections are updated based on a likelihood function of the associated nodes. Also, inputs to nodes are aggregated using t-norm or t-conorm functions, with outputs representing the possibility and belief measures. The aggregation methods presented offer an improvement over many other classification methods. Because of the form of the output, additional data evidence, including additional attributes, may be taken into account to improve classification without retraining the original data.

This application claims priority under 35 U.S.C. §119(c) from U.S. Provisional Patent Application No. 60/189,893 filed Mar. 16, 2000.

The invention described in this application was made with Government support by an employee of the U.S. Department of the Army. The Government has certain rights in the invention.

### FIELD OF THE INVENTION

This invention relates generally to an apparatus and method for performing fuzzy analysis of statistical evidence (FASE) utilizing the fuzzy set and the statistical theory for solving problems of pattern classification and knowledge discovery. Several features of FASE are similar to that of human judgment. It learns from data information, incorporates them into knowledge of beliefs, and it updates the beliefs with new information. The invention also related to what will be referred to as Plausible Neural Networks (PLANN).

### BACKGROUND OF THE INVENTION

Analog parallel distributed machines, or neural networks, compute fuzzy logic, which includes possibility, belief and probability measures. What fuzzy logic does for an analog machine is what Boolean logic does for a digital computer. Using Boolean logic, one can utilize a digital computer to perform theorem proving, chess playing, or many other applications that have precise or known rules. Similarly, based on fuzzy logic, one can employ an analog machine to perform approximate reasoning, plausible reasoning and belief judgment, where the rules are intrinsic, uncertain or contradictory. The belief judgment is represented by the possibility and belief measure, whereas Boolean logic is a special case or default. Fuzzy analysis of statistical evidence (FASE) can be more efficiently computed by an analog parallel-distributed machine. Furthermore, since FASE can extract fuzzy/belief rules, it can also serve as a link to distributed processing and symbolic process.

There is a continuous search for machine learning algorithms for pattern classification that offer higher precision and faster computation. However, due to the inconsistency of available data evidence, insufficient information provided by the attributes, and the fuzziness of the class boundary, machine learning algorithms (and even human experts) do not always make the correct classification. If there is uncertainty in the classification of a particular instance, one might need further information to clarify it. This often occurs in medical diagnosis, credit assessment, and many other applications.

Thus, it would be desirable to have a method for belief update with new attribute information without retraining the data sample. Such a method will offer the benefit of adding additional evidence (attributes) without resulting heavy computation cost.

Another problem with current methods of classifications is the widespread acceptance of the name Naïve Bayesian assumption. Bayesian belief updates rely on multiplication of attribute values, which requires the assumption that either the new attribute is independent of the previous attributes or that the conditional probability can be estimated. This assumption is not generally true, causing the new attribute to have a greater than appropriate effect on the outcome.

### SUMMARY OF THE INVENTION

To overcome these difficulties, the present invention offers a classification method based on possibility measure and aggregating the attribute information using a t-norm function of the fuzzy set theory. The method is described herein, and is referred to as fuzzy analysis of statistical evidence (FASE). The process of machine learning can be considered as the reasoning from training sample to population, which is an inductive inference. As observed in Y. Y. Chen, Bernoulli Trials: From a Fuzzy Measure Point of View. J. Math. Anal. Appl., vol. 175, pp. 392-404, 1993, and Y. Y. Chen, Statistical Inference based on the Possibility and Belief Measures, Trans. Amer. Math. Soc., vol. 347, pp. 1855-1863, 1995, which are here incorporated by reference, it is more advantageous to measure the inductive belief by the possibility and belief measures than by the probability measure.

FASE has several desirable properties. It is noise tolerant and able to handle missing values, and thus allows for the consideration of numerous attributes. This is important, since many patterns become separable when one increases the dimensionality of data.

FASE is also advantageous for knowledge discoveries in addition to classification. The statistical patterns extracted from the data can be represented by knowledge of beliefs, which in turn are propositions for an expert system. These propositions can be connected by inference rules. Thus, from machine learning to expert systems, FASE provides an improved link from inductive reasoning to deductive reasoning.

Furthermore a Plausible Neural Network (PLANN) is provided which includes weight connections which are updated based on the likelihood function of the attached neurons. Inputs to neurons are aggregated according to a t-conorm function, and outputs represent the possibility and belief measures.

### BRIEF DESCRIPTION OF THE DRAWINGS

The preferred embodiments of this invention are described in detail below, with reference to the drawing figures, wherein:

FIG. 1 illustrates the relationship between mutual information and neuron connections;

FIG. 2 illustrates the interconnection of a plurality of attribute neurons and class neurons;

FIG. 3 represents likelihood judgmnent in a neural network;

FIG. 4 is a flowchart showing the computation of weight updates between two neurons;

FIG. 5 depicts the probability distributions of petal-width;

FIG. 6 depicts the certainty factor curve for classification as a function of petal width;

FIG. 7 depicts the fuzzy membership for large petal width;

FIG. 8 is a functional block diagram of a system for performing fuzzy analysis of statistical evidence.

FIG. 9 is a flow chart showing the cognitive process of belief judgment;

FIG. 10 is a flow chart showing the cognitive process of supervised learning;

FIG. 11 is a flow chart showing the cognitive process of knowledge discovery;

FIG. 12 is a diagram of a two layer neural network according to the present invention; and

FIG. 13 is a diagram of an example of a Bayesian Neural Network and a Possibilistic Neural Network in use.

### DETAILED DESCRIPTION OF THE PREFERRED EMBODIMENTS

### 1. FASE Methodologies and Properties

Let C be the class variable and A₁, . . . , Aₙ be the attribute variables; and let Pos be the possibility measures. Based on the statistical inference developed in Y. Y. Chen, Bernoulli Trials: From a Fuzzy Measure Point of View, J Math. Anal Appl., Vol. 175, pp. 392-404, 1993, we have

Pos(C|A₁, . . . , Aₙ)=Pr(A₁, . . . , Aₙ|C)/sup_{c}Pr(A₁, . . . , Aₙ|C), (1)

if the prior belief is uninformative. Bel (C| A₁, . . . , Aₙ)=1−Pos (\overline{C}|A₁, . . . , Aₙ) is the belief measure or certainty factor (CF) that an instance belongs to class C.

The difference between equation (1) and the Bayes formula is simply the difference of the normalization constant. In possibility measure the sup norm is 1, while in probability measure the additive norm (integration) is 1. For class assignment, the Bayesian classifier is based upon the maximum a posteriori probability, which is again equivalent to maximum possibility.

In machine learning, due to the limitation of the training sample and/or large number of attributes, the joint probability Pr (A₁, . . . , Aₙ|C) is very often not directly estimated from the data. This problem is similar to the curse of dimensionality. If one estimates the conditional probability Pr (Aᵢ|C) or Pr (Aᵢ₁, . . . , AᵢₖC) separately, where {i₁, . . . , iₖ} form a partition of {1, . . . , n}, then a suitable operation is needed to combine them together.

Next we give a definition of t-norm functions, which are often used for the conjunction of fuzzy sets. A fuzzy intersection/t-norm is a binary operation T: [0,1]×[0,1]→[0,1], which is communicative and associative, and satisfies the following conditions (cf [5]):

(i)T(a, 1)=a, for all a,

and

(ii)T(a, b)≦T(c, d) whenever a≦c, b≦d. (2)

The following are examples of t-norms that are frequently used in the literatures:

Minimum: M (a, b)=min (a, b)

Product: Π (a, b)=ab.

Bounded difference: W (a, b)=max (0, a+b−1).

And we have W≦Π≦M.

Based on the different relationships of the attributes, we have different belief update rules. In general:

Pos(C|A₁, A₂)=Pos(C₁|A₁)\mathring{x}Pos(C|A₂)/sup_{c}Pos(C|A₁)\mathring{x}Pos(C|A₂), (3)

where \mathring{x} is a t-norm operation. If A₁ and A₂ are independent, then \mathring{x} is the product Π (Y. Y. Chen, Bernoulli Trials: From a Fuzzy Measure Point of View, J. Math. Anal. Appl., Vol. 175, pp. 392-404, 1993). And if A₁ and A₂ are completely dependent, i.e. Pr (A₁|A₂)=1 and Pr (A₂|A₂)=1, then we have:

Pos(C|A₁, A₂)=Pos(C|A₁)ˆ Pos (C|A₂)/sup_{c}Pos(C|A₁)ˆ Pos(C|A₂), (4)

where ˆ is a minimum operation. This holds since Pos (C|A₁, A₂)=Pos (C|A₁)=Pos (C|A₂). Note that if A₁, A₂ are functions of each other, they are completely dependent, thus making the evidences redundant.

While generally the relations among the attributes are unknown, a t-norm can be employed in between Π and M for a belief update. Thus, a t-norm can be chosen which more closely compensates for varying degrees of dependence between attributes, without needing to know the actual dependency relationship. For simplicity, we confine our attention to the model that aggregates all attributes with a common t-norm \mathring{x} as follows:

Pos(C|A₁, . . . , Aₙ)=\mathring{x}_{i=1, . . . ,n}Pos(C|Aᵢ)/sup_{C}\mathring{x}_{i=1, . . . n}Pos(C|Aᵢ), (5)

which includes the naïve Bayesian classifier as a special case, i.e. when \mathring{x} equal to the product Π. As shown in Y. Y. Chen, Statistical Inference based on the Possibility and Belief Measures, Trans. Amer. Math. Soc., vol. 347, pp. 1855-1863, 1995, the product rule implies adding the weights of evidence. It will overcompensate the weight of evidences, if the attributes are dependent.

The following are some characteristic properties of FASE:

(a) For any t-norm, if attribute Aᵢ is noninformative, i.e. Pos (C=cⱼ|Aᵢ)=1, ∀j, then:

Pos(C|A₁, . . . , Aₙ)=Pos(C|A₁, . . . , Aᵢ₋₁, Aᵢ₊₁, . . . , Aₙ). (6)

This holds since T (a, 1)=a.

Equation (6) indicates that a noninformative attribute did not contribute any evidence for overall classification, and it happens when an instance aᵢ is missing or Aᵢ is a constant. Similarly if Aᵢ is white noise, then it provides little information for classification, since Pos (C=_{cj}|Aᵢ)≈1, ∀j. Thus, FASE is noise tolerant.

(b) For any t-norm, if Pos (C|Aᵢ)=0 for some i, then:

Pos(C|A₁, . . . , Aₙ)=0. (7)

This holds since T (a, 0)=0.

Equation (7) indicates that the process of belief update is by eliminating the less plausible classes/hypothesis, i.e. Pos (C|Aᵢ)≈0, based on evidences. The ones that survive the process become the truth.

(c) For binary classification, if Bel (C=C_{cj}|A₁)=a, Bel (C≠Cᵢ|A₂)=b, and 0<b≦a, then:

Bel(C=Cⱼ|A₁, A₂)=(a−b)/(1−b). (8)

Given that (a−b)/(1−b)≦a, equation (8) implies that conflicting evidence will lower our confidence of the previous beliefs; however, the computation is the same regardless of which t-norm is used. If the evidence points to the same direction, i.e. Bel (C=Cⱼ|A₁)=a, and Bel (C=Cⱼ|A₂)=b, 0<a, b≦1, then our confidence level will increase. The confidence measure Bel (C=Cⱼ|A₁, A₂) ranges from max (a, b) to a+b-ab, for t-norm functions in between M (minimum) and Π product). The larger the t-norm the weaker the weight of evidence it reckons with. This property can be referred to as the strength of the t-norm.

Thus if we employ different t-norms to combine attributes, the computations are quite similar to each other. This also explains why the naive Bayesian classifier can perform adequately, even though the independence assumption is very often violated.

### 2. Plausible Neural Networks

In human reasoning, there are two modes of thinking: expectation and likelihood. Expectation is used to plan or to predict the true state of the future. Likelihood is used for judging the truth of a current state. The two modes of thinking are not exclusive, but rather they interact with each other. For example, we need to recognize our environment in order to make a decision. A statistical inference model that interacts these two modes of thinking was discussed in Chen (1993), which is a hybrid of probability and possibility measures.

The relationships between statistical inferences and neural networks in machine learning and pattern recognition have attracted considerable research attention. Previous connections were discussed in terms of the Bayesian inference (see for example Kononenko I. (1989) Bayesian Neural Networks, Biological Cybernetics 61:361-370; and MacKay D. J. C., A Practical Bayesian Framework for Backpropagation Networks. Neural Computation 4, 448-472, 1992; or the statistical learning theory Vapnik V., Statistical Learning Theory, Wiley, N.Y., 1998). Bayesian neural networks require the assignment of prior belief on the weight distributions of the network. Unfortunately, this makes the computation of large-scale networks almost impossible. Statistical learning theory does not have the uncertainty measure of the inference, thus it can not be updated with new information without retraining the variable.

According to the present invention, for each variable X there are two distinct meanings. One is P(X), which considers the population distribution of X, and the other is Pr (X), which is a random sample based on the population. If the population P (X) is unknown, it can be considered as a fuzzy variable or a fuzzy function (which is referred to as stationary variable or stationary process in Chen (1993)). Based on sample statistics we can have a likelihood estimate of P(X). The advantage of using the possibility measure on a population is that it has a universal vacuous prior, thus the prior does not need to be considered as it does in the Bayesian inference.

According to the present invention, X is a binary variable that represents a neuron. At any given time, X=1 represents the neuron firing, and X=0 represents the neuron at rest. A weight connection between neuron X and neuron Y is given as follows:

ω₁₂=log(P(X, Y)|P(X)P(Y)), (9)

which is the mutual information between the two neurons.

Linking the neuron's synapse weight to information theory has several advantages. First, knowledge is given by synapse weight. Also, information and energy are interchangeable. Thus, neuron learning is statistical inference.

From a statistical inference point of view, neuron activity for a pair of connected neurons is given by Bernoulli's trial for two dependent random variables. The Bernoulli trial of a single random variable is discussed in Chen (1993).

Let P (X)=θ₁, P (Y)=θ₂, P (X,Y)=θ₁₂, and g(θ₁, θ₂, θ₁₂)=log(θ₁₂/θ₁θ₂). The likelihood function of ω₁₂ given data x, y is

$$l ( {ω}_{12} \vert x , y ) = {sup}_{{θ}_{1} , {θ}_{2} {{θ}_{12}}_{{ω}_{12} = g ( {θ}_{1} , {θ}_{2} , {θ}_{12} )}} log ( {{θ}_{{12}^{xy}} ( {θ}_{1} - {θ}_{12} )}^{x ( 1 - y )} {( {θ}_{2} - {θ}_{12} )}^{( 1 - x ) y} {( 1 - {θ}_{1} - {θ}_{2} + {θ}_{12} )}^{( 1 - x ) ( 1 - y )} / {{θ}_{1}^{x} ( 1 - {θ}_{1} )}^{1 - x} {{θ}_{{2}^{y}} ( 1 - {θ}_{2} )}^{1 - y} ) \qquad ( 10 )$$

This is based on the extension principle of the fuzzy set theory. When a synapse with a memory of x, y (based on the weight ω₁₂) receives new information x₁, y₁, the likelihood function of weight is updated by the likelihood rule:

l(ω₁₂|x, y, xₜyₜ)=l(ω₁₂|x y)l(ω₁₂|x₁,y)/sup₁₀₇ _{₁₂}l(ω₁₂|x,y)l(ω₁₂|x₁, yₜ) (11a)

Those of skill in the art will recognize that equation (11a) represents the Hebb rule. Current neural network research uses all manner of approximation methods. The Bayesian inference needs a prior assumption and the probability measure is not scalar invariant under transformation. Equation (11a) can be used to design an electronic device to control the synapse weights in a parallel distributed computing machine.

For data analysis, a confidence measure for ω₁₂ is represented by the a α-cut set or 1-α likelihood interval, which is described in Y. Y. Chen, Statistical Inference based on the Possibility and Belief Measures, Trans. Amer. Math. Soc., Vol. 347, pp. 1855-1863, 1995. This is needed only if the size of the training sample is small. If the sample size is large enough the maximum likelihood estimate of ω₁₂ will be sufficient, which can be computed from the maximum likelihood estimate of θ₁, θ₂ and η₁₂. Since \hat{θ}₁=Σ_{ixi/n},

$${\hat{θ}}_{b} = {\sum }_{i} {y}_{i} / n , {\hat{θ}}_{11} = {\sum }_{i} {x}_{i} {y}_{i} / n , we have \\ {\hat{ϖ}}_{12} = log ( n {\sum }_{i} {x}_{i} {y}_{i} / {\sum }_{i} {x}_{i} {\sum }_{i} {y}_{i} ) , \qquad \text{(11b)}$$

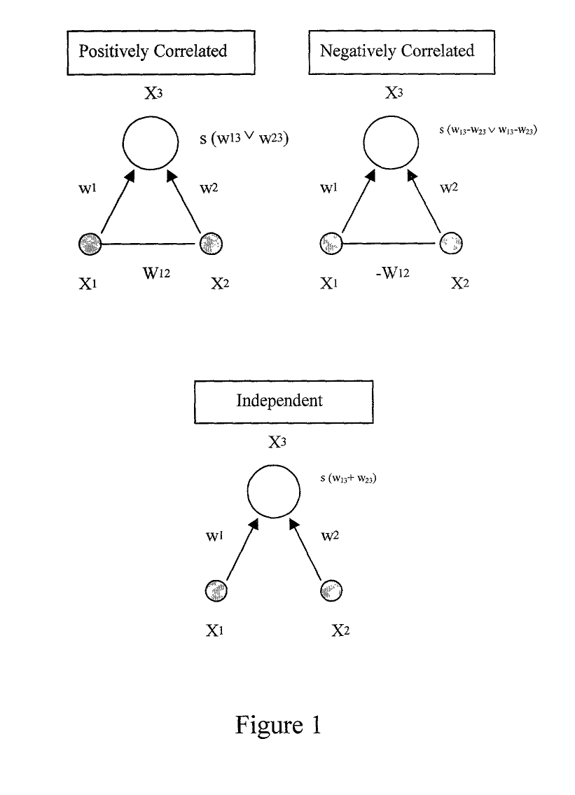

Both Equations (11a) and (11b) may be used in a plausible neural network (PLANN) for updating weights. Equation (11b) is used for data analysis. Equation (11a) may be used in a parallel distributed machine or a simulated neural network. As illustrated in FIG. 1, from equation (9) we see that

ω₁₂>0 if X and Y are positively correlated,

ω₁₂<0 if X and Y are negatively correlated,

ω₁₂=0 if and only if X and Y are statistically independent.

If neuron X and neuron Y are close to independent, i.e. ω₁₂≈0, their connections can be dropped, since it will not affect the overall network computation. Thus a network which is initially fully connected can become a sparsely connected network with some hierarchical structures after training. This is advantageous because neurons can free the weight connection to save energy and grow the weight connection for further information process purposes.

A plausible neural network (PLANN) according to the present invention is a fully connected network with the weight connections given by mutual information. This is usually called recurrent network.

Symmetry of the weight connections ensures the stable state of the network (Hopfield, J. J., Learning Algorithm and Probability Distributions in Feed-Forward and Feed-Back Networks, Proceedings at the National Academy of Science, U.S.A., 8429-8433 (1985)). Xⱼ is the set of neurons that are connected with and which fire to the neuron Xᵢ. The activation of Xᵢ is given by

Xᵢ=s\mathring{x}ⱼωᵢⱼxⱼ), (12)

The signal function can be deterministic or stochastic, and the transfer function can be sigmoid or binary threshold. Each represents a different kind of machine. The present invention focuses on the stochastic sigmoid function, because it is closer to a biological brain.

The stochastic sigmoid model with additive activation is equivalent to a Boltzmann machine described in Ackley, D. H., Hinton, G. E., and T. J. Sejnowski, A Learning Algorithm for Boltzmann, Cognitive Sci. 9, pp. 147-169 (1985). However, the PLANN learning algorithm of the present invention is much faster than a Boltzmann machine because each data information neuron received is automatically added to the synapse weight by equation (11a). Thus, the training method of the present invention more closely models the behavior of biological neurons.

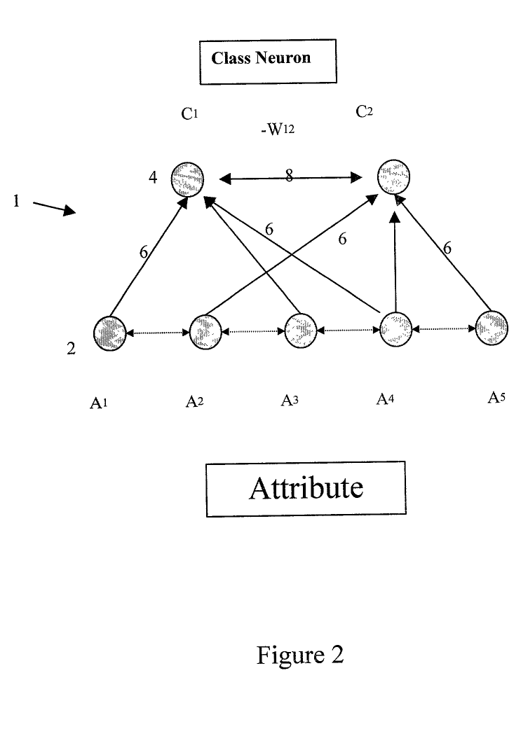

The present invention has the ability to perform plausibility reasoning. A neural network with this ability is illustrated in FIG. 2. The neural network employs fuzzy application of statistical evidence (FASE) as described above. As seen in FIG. 2, the embodiment shown is a single layer neural network 1, with a plurality of attribute neurons 2 connected to a plurality of class neurons 4. The attribute neurons 2 are connected to the class neurons 4 with weight connections 6. Each class neuron aggregates the inputs from the attribute neurons 2. Under signal transformation the t-conorm function becomes a t-norm, thus FASE aggregates information with a t-norm.

The attribute neurons that are statistically independent of a class neuron have no weight connection to the class neuron. Thus, statistically independent neurons do not contribute any evidence for the particular class. For instance, in FIG. 2 there is no connection between attribute neuron A₂ and class neuron C₁. Similarly there is no connection between attribute neuron A₃ and class neuron C₂.

The signals sent to class neurons 4 are possibilities. The class neurons 4 are interconnected with exhibition weights 8. In a competitive nature, the energy in each class neuron diminishes the output of other class neurons. The difference between the possibilities is the belief measure. Thus, if two class neurons have very similar possibility measures, the belief measure will be low. The low belief energy represents the low actual belief that the particular class neuron is the correct output. On the other hand, if the possibility measure of one class neuron is much higher than any other class neurons, the belief measure will be high, indicating higher confidence that the correct class neuron has been selected.

In the example of FIG. 2, the weight connections among the attribute neurons were not estimated. However, the true relationship between attributes may have different kinds of inhibition and exhibition weights between attribute neurons. Thus, the energy of attribute neurons would cancel out the energy of other attribute neurons. The average t-norm performs the best.

In the commonly used naives Bayes, the assumption is that all attributes are independent of each other. Thus, there are no connection weights among the attribute neurons. Under this scheme, the class neurons receive overloaded information/energy, and the beliefs quickly become close to 0 or 1. FASE is more robust accurate, because weights between attribute neurons are taken into consideration, thus more accurately representing the interdependence of attribute neurons.

Those of skill in the art will appreciate the broad scope of application of the present invention. Each output neuron signal can be a fuzzy class, and its meanings depend on the context. For classification the outputs will mean possibility and belief. For forecasting, the outputs will mean probability. It will be appreciated that other meanings are also possible, and will be discovered given further research.

As discussed above, there are two modes of human thinking: expectation and likelihood. Expectation can be modeled in a forward neural network. Likelihood can be modeled with a backward neural network. Preferably, the neural network is a fully connected network, and whether the network works backwards or forwards is determined by the timing of events. In a forward neural network energy disperses, which is not reinforced by data information, and the probability measure is small. A backward neural network receives energy, and thus the possibility is large. If several neurons have approximately equal possibilities, their exhibition connections diminish their activities, only the neurons with higher energy levels remain active.

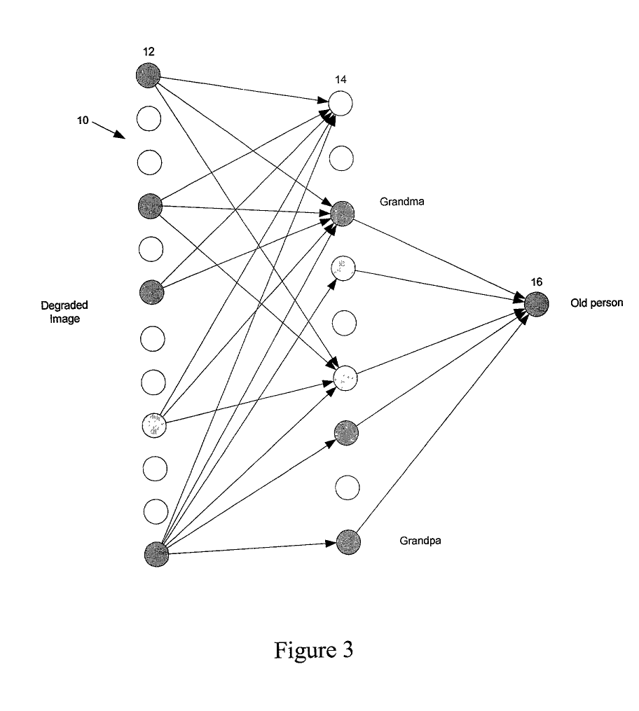

FIG. 3 illustrates a neural network for performing image recognition. The network 10 comprises a first layer 12 and a second layer 14 of nodes or neurons. This network also has a third layer 16. In this illustration, the network receives degraded image information at the input layer 12. The input nodes fire to the second layer neurons 14, and grandma and grandpa receive the highest aggregation of inputs. The belief that the image represents one or the other, however, is very small, because the possibility values were very close. Thus, the network knows the image is of grandma or grandpa, but is not confident that it knows which. This information is aggregated further, however, into a very high possibility and belief value for a neuron representing “old person” 16.

Thus, if the attribute neurons represent inputs to an image recognition network, a degraded image can eventually be classified as an old person. This is an example of a forward network. Forward networks may be interacted with backward networks. A design like this is discussed in ART (Grossberg S., The Adaptive Brain, 2 Vol. Amsterdam: Elsevier (1987)). This type of network can be interpreted as the interaction of probability and possibility, and becomes the plausibility measure, as discussed in Chen (1993).

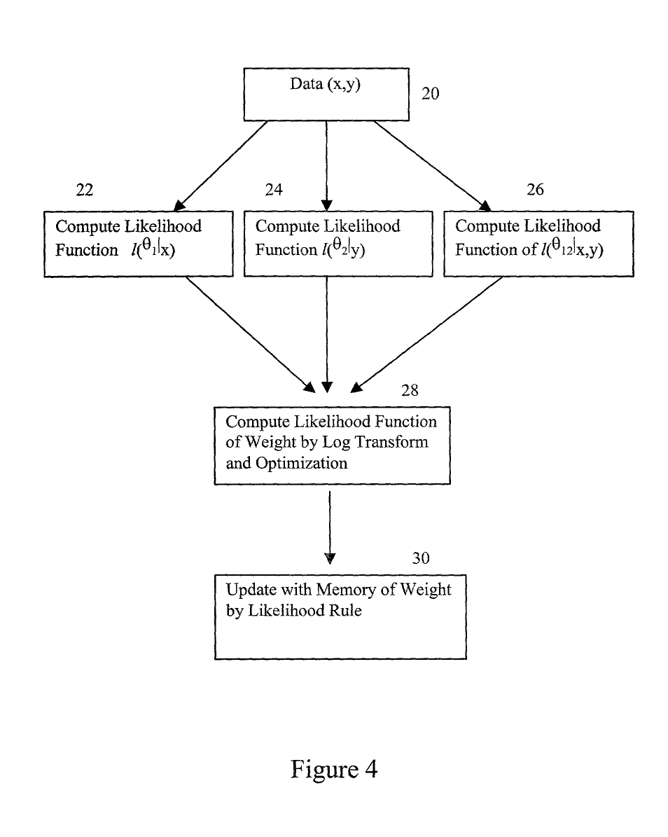

A plausible neural network according to the present invention calculates and updates weight connections as illustrated in FIG. 4. Data is entered into the network at step 20. For a particular weight connection that connects neurons X and Y, three likelihood calculations are performed. The likelihood function is computed according to equation (10) above. The likelihood function is calculated for parameter θ₁ 22, parameter θ₂ 24, and parameter θ₁₂ 26. Next, the likelihood function of the weight connection is computed by the log transform and optimization 28. Finally, the likelihood rule described above is used to update the memory of the weight connection 30.

Now data coding in a neural network will be described. Let each neuron be an indicator function representing whether a particular data value exists or not. With the information about the relationship between the data values, many network architectures can be added to the neuron connection. If a variable is discrete with k categories scale, it can be represented by X₋ (X₁, X₂, . . . , Xₖ), which is the ordinary binary coding scheme. However, if these categories are mutually exclusive, then inhibition connections are assigned to any pair of neurons to make them competitive. If the variable is of ordinal scale, then we arrange X₁, X₂, . . . , Xₖ in its proper order with the weak inhibition connection between the adjacent neurons and strong inhibition between distant neurons. If the variable is continuous, the X₁, X₂, . . . , Xₖ are indicator functions of an interval or bin with proper order. We can assign exhibition connections between neighboring neurons and inhibition connections for distant neurons. One good candidate is the Kohonen network architecture. Since a continuous variable can only be measured with a certain degree of accuracy, a binary vector with a finite length is sufficient. This approach also covers the fuzzy set coding, since the fuzzy categories are usually of ordinal scale.

For pattern classification problems, the solution is connecting a class network, which is competitive, to an attribute network. Depending on the information provided in the class labels of the training samples, such a network can perform supervised learning, semi-supervised learning, or simply unsupervised learning. Varieties of classification schemes can be considered. Class variable can be continuous, and class categories can be crisp or fuzzy. By designing weight connections between the class neurons, the classes can be arranged as a hierarchy or they can be unrelated.

For forecasting problems, such as weather forecasting or predicting the stock market, PLANN makes predictions with uncertainty measures. Since it is constantly learning, the prediction is constantly updated.

It is important to recognize that the neuron learning mechanism is universal. The plausible reasoning processes are those that surface to the conscious level. For a robotic learning problem, the PLANN process speeds up the learning process for the robot.

PLANN is the fastest machine learning process known. It has an exact formula for weight update, and the computation only involves first and second order statistics. PLANN is primarily used for large-scale data computation.

(i) PLANN Training for Parallel Distributed Machines

A parallel distributed machine according to the present invention may be constructed as follows. The parallel distributed machine is constructed with many processing units, and a device to compute weight updates as described in equation (11a). The machine is programmed to use the additive activation function. Training data is input to the neural network machine. The weights are updated with each datum processed. Data is entered until the machine performs as desired. Finally, once the machine is performing as desired, the weights are frozen for the machine to continue performing the specific task. Alternatively, the weights can be allowed to continuously update for an interactive learning process.

(ii) PLANN Training for Simulated Neural Networks

A simulated neural network can be constructed according to the present invention as follows. Let (X₁, X₂, . . . , X_{N}) represent the neurons in the network, and ωᵢⱼ be the weight connection between Xᵢ and Xᵢ. The weights may be assigned randomly. Data is input and first and second order statistics are counted. The statistical information is recorded in a register. If the data records are of higher dimensions, they may be broken down into lower dimensional data, such that mutual information is low. Then the statistics are counted separately for the lower dimensional data. More data can be input and stored in the register. The weight ωᵢⱼ is periodically updated by computing statistics from the data input based on equation (11). The performance can then be tested.

As an example, dog bark data is considered. For slower training, the dog bark data by itself may be input repeatedly without weight connection information. The weights will develop with more and more data entered. For faster training, the dog bark data with weight connections may be entered into the network. An appropriate data-coding scheme may be selected for different kinds of variables. Data is input until the network performs as desired.

(iii) PLANN for Data Analysis

In order to use PLANN to analyze data, the data is preferably reduced to sections with smaller dimensions. First and second order statistics may then be computed for each section. A moderate strength t-conorm/t-norm is used to aggregate information. The true relationship between variables averages out.

The present invention links statistical inference, physics, biology, and information theories within a single framework. Each can be explained by the other. McCulloch, W. S. and Pitts, A logical Calculus of Ideas Immanent in Neuron Activity, Bulletin of Mathematical Biology 5, pp. 115-133, 1943 shows that neurons can do universal computing with a binary threshold signal function. The present invention performs universal computing by connecting neurons with weight function given in equation (11a). Those of skill in the art will recognize that with different signal functions, a universal analog computing machine, a universal digital computation machine, and hybrids of the two kinds of machines can be described and constructed.

### 3. FASE Computation and Experimental Results

It will be apparent to one of skill in the art that FASE is applied with equal success to classifications involving fuzzy and/or continuous attributes, as well as fuzzy and/or continuous classes. For continuous attributes, we employ the kernel estimator D. W. Scott, Multivariate Density Estimation: Theory, Practice, and Visualization., John Wiley & Sons, 1992, chap. 6, pp. 125 for density estimation

p(x)=1/nhΣᵢK((x−xᵢ)/h), (13)

where K is chosen to be uniform for simplicity. For discrete attributes we use the maximum likelihood estimates. The estimated probabilities from each attribute are normalized into possibilities and then combined by a t-norm as in equation (12).

We examine the following two families of t-norms to aggregate the attributes information, since these t-norms contain a wide range of fuzzy operators. One is proposed by M. J. Frank, On the Simultaneous Associativity of F (x, y) and X+y-F (x, y, Aequationes Math., Vol. 19, pp. 194-226, 1979 as follows:

Tₛ(a, b)=logₛ(1+(S^{a}−1)(S^{b}−1)/(s−1)), for 0<s<∞. (14)

We have Tₛ=M, as s→0, Tₛ=Π, as s→1 and Tₛ=W, as s→∞.

The other family of t-norms is proposed by B. Schweizer and A. Sklar, Associative Functions and Abstract Semi-groups. Publ. Math. Debrecen, Vol. 10, pp. 69-81, 1963, as follows:

Tₚ(a, b)=(max (0, a^{p}+b^{p}−1))^{1/p}, for−∞<p<∞. (15)

We have Tp=M, as p→−∞, Tₚ=Π, as p→0 and Tₚ=W, as p→1.

For binary classifications, if we are interested in the disciminant power of each attribute, then the information of divergence (see S. Kullback, Information Theory and Statistics, Dover, N.Y., Chap. 1, pp. 6, 1968) can be applied, which is given by:

I(p₁, p₂)=Σₓ(p₁)(x)−(p₂(x))log(p₁(x)/p₂(x)). (16)

FASE does not require consideration of the prior. However, if we multiply the prior, in terms of possibility measures, to the likelihood, then it discounts the evidence of certain classes. In a loose sense, prior can also be considered as a type of evidence.

The data sets used in our experiments come from the UCI repository C. L. Blake, and C. J. Merz, UCI Repository of Machine Learning Databases [http://www.ics.uci.edu/˜mlearn/MLRepository.html], 1998. A five-fold cross validation method (see R. A. Kohavi, Study of Cross-Validation and Bootstrap for Accuracy Estimation and Model Selection, Proceedings of the Fourteenth International Joint Conference for Artificial Intelligence, Morgan Kaufmann, San Francisco, pp. 1137-1143, 1995) was used for prediction accuracy. This computation is based on all records, including those with missing values. In the training set those non-missing values still provide useful information for model estimation. If an instance has missing values, which are assigned as null beliefs, its classification is based on a lesser number of attributes. But, very often we do not require all of the attributes to make the correct classification. Even though the horse-colic data are missing 30% of its values, FASE still performs reasonably well.

TABLE 1
Experimental results of FASE model with a common t-norm

| | | | |
|---|---|---|---|
| Data set | t-norm parameter** | II | M |

| | | | | |
|---|---|---|---|---|
| 1 Australian | s = .75 | 85.0 | 84.7 | 81.8 |
| 2 breast* | s = .5 | 96.7 | 96.7 | 96.2 |
| 3 crx* | s = .1 | 85.5 | 84.9 | 83.9 |
| 4 DNA | s = .5 | 95.5 | 94.3 | 82.5 |
| 5 heart | s = .8 | 82.3 | 82.3 | 81.1 |
| 6 hepatitis* | p = −.1 | 85.4 | 85.3 | 84.7 |
| 7 horse-colic* | p = −3 | 80.7 | 79.0 | 80.2 |
| 8 inosphere | s = .7 | 88.5 | 88.5 | 83.8 |
| 9 iris | s = .5 | 93.3 | 93.3 | 93.3 |
| 10 soybean* | p = −.1 | 90.1 | 89.8 | 87.7 |
| 11 waveform | s = .1 | 84.2 | 83.6 | 80.9 |
| 12 vote* | p = −8 | 94.9 | 90.3 | 95.2 |

*Data set with missing values.
**t-norm parameters that perform well for the data set.
s-Frank parameter, p-Schweizer & Sklar parameter

T-norms stronger than the product are less interesting and do not perform as well, so they are not included. Min rule reflects the strongest evidence among the attributes. It does not perform well if we need to aggregate a large number of independent attributes, such as the DNA data. However it performs the best if the attributes are strongly dependent on each other, such as the vote data.

In some data sets, the classification is insensitive to which t-norm was used. This can be explained by equations (2) and (3). However, a weaker t-norm usually provides a more reasonable estimate for confidence measures, especially if the number of attributes is large. Even though those are not the true confidence measures, a lower CF usually indicates there are conflicting attributes. Thus, they still offer essential information for classification. For example in the crx data, FASE classifier, with s=0.1, is approximately 85% accurate. If one considers those instances with a higher confidence, e.g. CF>0.9, then an accuracy over 95% can be achieved.

### 4. Knowledge Discoveries and Inference Rules

Based on the data information of class attributes, expert-system like rules can be extracted by employing the FASE methodology. We illustrate it with the Fisher's iris data, for its historical grounds and its common acknowledgment in the literatures:

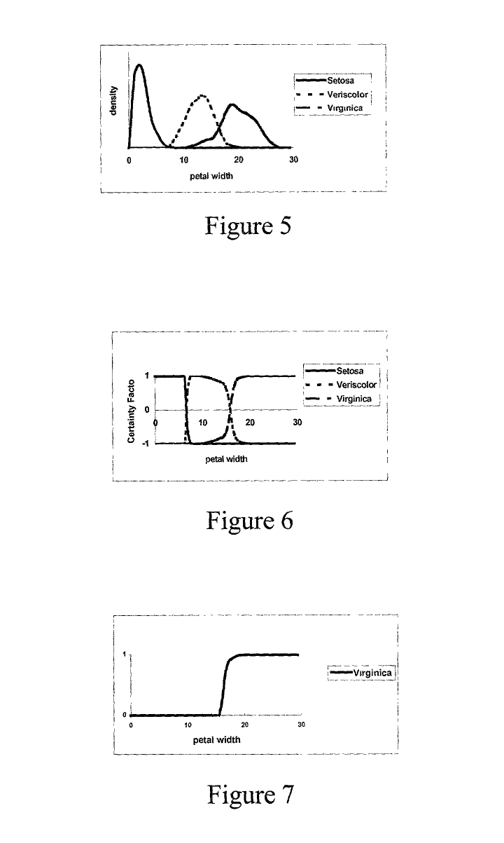

FIGS. 5-7 illustrate the transformation from class probabilities to class certainty factors and fuzzy sets. FIG. 5 shows probability distributions of petal-width for the three species, FIG. 6 shows the certainty factor (CF) curve for classification as a function of petal width, and FIG. 7 shows fuzzy membership for “large” petal width.

FIGS. 5-7 show the class probability distributions and their transformation into belief measures, which are represented as certainty factors (CF). CF is supposed to be positive, but it is convenient to represent disconfirmation of a hypothesis by a negative number.

Bel (C|A) can be interpreted as “If A then C with certainty factor CF”. Those of skill in the art will appreciate that A can be a single value, a set, or a fuzzy set. In general, the certainty factor can be calculated as follows:

Bel(C|Ã)= [symbol] x_{ε}x Bel(C|x) [symbol] μ(Ã(x)) (17)

where μ (Ã (x)) is the fuzzy membership of Ã.

If we let μ (Ã (x))=Bel (C=Virginica|x) as the fuzzy set “large” for petal width, as shown in FIG. 7, then we have a rule like “If the petal width is large then the iris specie is Virginica.”

The certainty factor of this proposition coincides with the truth of the premise xεÃ, it need not be specified. Thus, under FASE methodology, fuzzy sets and fuzzy propositions can be objectively derived from the data.

Each belief statement is a proposition that confirms C, disconfirms C, or neither. If the CF of a proposition is low, it will not have much effect on the combined belief and can be neglected. Only those propositions with a high degree of belief are extracted and used as the expert system rules. The inference rule for combining certainty factors of the propositions is based on the t-norm as given in equation (3). It has been shown in C. L. Blake, and C. J. Merz, UCI Repository of machine learning databases. [http://www.ics.uci.edu/˜mlearn/MLRepository.html], 1998 that the MYCIN CF model can be considered as a special case of FASE, and its combination rule (see E. H. Shortliffe and B. G. Buchanan, A Model of Inexact Reasoning in Medicine, Mathematical Biosciences, Vol. 23, pp. 351-379, 1975) is equivalent to the product rule under the possibility measures. Thus, MYCIN inferences unwittingly assume the independence of propositions.

The combined belief Bel (C|A₁, A₂) can be interpreted as “If A₁ and A₂ then C with certainty factor CF”. However, very often we do not place such a proposition as a rule unless both attributes are needed in order to attain a high degree of belief, e.g. XOR problems. This requires estimation of the joint probabilities and conversion into the possibility and belief measures.

In the forgoing description, we have introduced a general framework of FASE methodologies for pattern classification and knowledge discovery. For experiments we limited our investigation to a simple model of aggregating attributes information with a common t-norm. The reward of such a model is that it is fast in computation and its knowledge discovered is easy to empathize. It can perform well if the individual class attributes provide discriminate information for the classification, such as shown in FIGS. 5-7. In those situations a precise belief model is not very crucial. If the classification problems are relying on the joint relationships of the attributes, such as XOR problems, this model will be unsuccessful. Preferably one would like to estimate the joint probability of all class attributes, but with the combinatorial affect there is always a limitation. Furthermore, if the dimension of probability estimation is high, the knowledge extracted will be less comprehensible. A method for belief update with attribute information is always desirable.

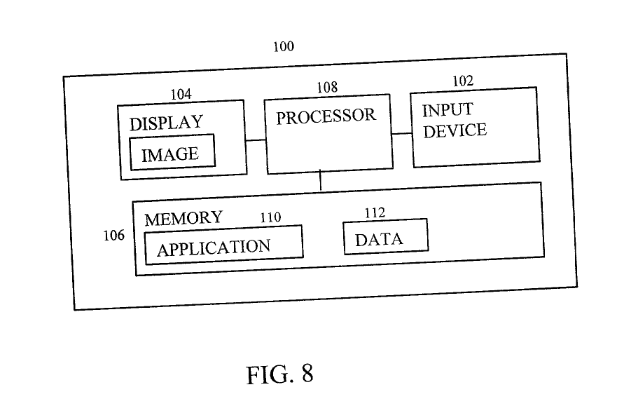

FIG. 8 is a block diagram of a system 100 which can be used to carry out FASE according to the present invention. The system 100 can include a computer, including a user input device 102, an output device 104, and memory 106 connected to a processor 108. The output device 104 can be a visual display device such as a CRT monitor or LCD monitor, a projector and screen, a printer, or any other device that allows a user to visually observe images. The memory 106 preferably stores both a set of instructions 110, and data 112 to be operated on. Those of skill in the art will of course appriciate that separate memories could also be used to store the instructions 110 and data 112.

The memory 106 is preferably implemented using static or dynamic RAM. However, the memory can also be implemented using a floppy disk and disk drive, a writeable optical disk and disk drive, a hard drive, flash memory, or the like.

The user input device 102 can be a keyboard, a pointing device such as a mouse, a touch screen, a visual interface, an audio interface such as a microphone and an analog to digital audio converter, a scanner, a tape reader, or any other device that allows a user to input information to the system.

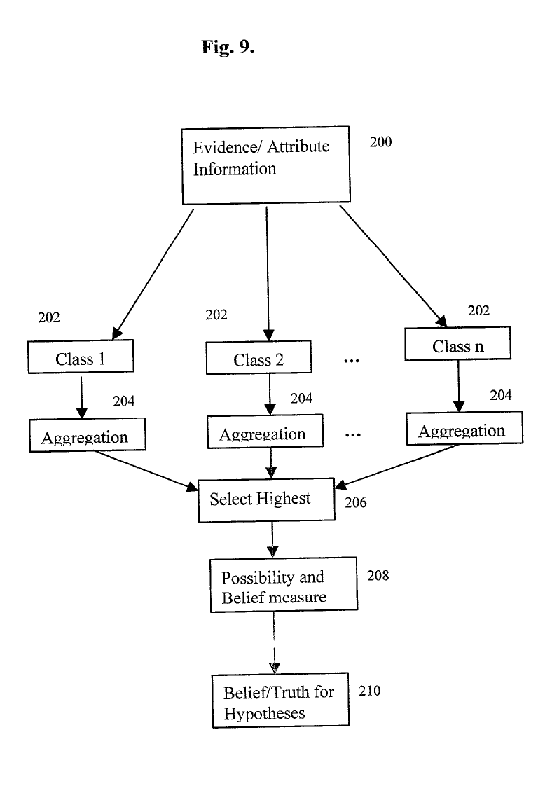

The processor 108 is preferably implemented on a programmable general purpose computer. However, as will be understood by those of skill in the art, the processor 108 can also be implemented on a special purpose computer, a programmable microprocessor or a microcontroller and peripheral integrated circuit elements, an ASIC or other integrated circuit, a digital signal processor, a hard-wired electronic or logic circuit such as a discrete element circuit, a programmable logic device such as a PLD, PLA, FPGA or PAL, or the like. In general, any device capable of implementing the steps shown in FIGS. 9-11 can be used to implement the processor 108.

In the preferred embodiment, the system for performing fuzzy analysis of statistical evidence is a computer software program installed on an analog parallel distributed machine or neural network. It will be understood by one skilled in the art that the computer software program can be installed and executed on many different kinds of computers, including personal computers, minicomputers and mainframes, having different processor architectures, both digital and analog, including, for example, X86-based, Macintosh G3 Motorola processor based computers, and workstations based on SPARC and ULTRA-SPARC architecture, and all their respective clones. The processor 108 may also include a graphical user interface editor which allows a user to edit an image displayed on the display device.

Alternatively, the system for performing fuzzy analysis of statistical evidence is also designed for a new breed of machines that do not require human programming. These machines learn through data and organize the knowledge for future judgment. The hardware or neural network is a collection of processing units with many interconnections, and the strength of the interconnections can be modified through the learning process just like a human being.

An alternative approach is using neural networks for estimating a posteriori beliefs. Most of the literature (e.g., M. D. Richard and R. P. Lippmann, Neural Networks Classifiers Estimate Bayesian a Posteriori Probabilities, Neural Computation, Vol. 3, pp. 461-483, 1991) represents the posterior beliefs by probability measures, but they can be represented by the possibility measures as well. Heuristically the possibility and belief measures are more suitable to portray the competitive nature of neuron activities for hypothesis forming. Many other principles of machine learning, e.g. E-M algorithms, can also be interpreted by the interaction of probability (expectation) and possibility (maximum likelihood) measures.

FIGS. 9-11 are flow charts illustrating fuzzy analysis of statistical evidence for analyzing information input into or taken from a database. The preferred method of classifying based on possibility and belief judgement is illustrated in FIG. 9. The method illustrated in FIG. 9 can be performed by a computer system as a computer system 100 as illustrated in FIG. 8, and as will be readily understood by those familiar with the art could also be performed by an analog distributed machine or neural network. The following description will illustrate the methods according to the present invention using discrete attributes. However, as will be appreciated by those skilled in the art, the methods of the present invention can be applied equally well using continuous attributes of fuzzy attributes. Similarly, the methods of the present invention apply equally well to continuous or fuzzy classes although the present embodiment is illustrated using discrete classes for purposes of simplicity. At step 200, data corresponding to one instance of an item to be classified is retrieved from a data base 112 and transmitted to the process 108 for processing. This particular instance of data will have a plurality of values associated with the plurality of attributes. At step 202, the attribute data is processed for each of the N possible classes. It will be appreciated at an analog distributive machine or neural network the attribute data for each of the classes can be processed simultaneously, while in a typical digital computer the attribute data may have to be sequentially processed for each of the possible classes. At step 204, the attribute data is aggregated for each of the classes according to the selected t-norm, which is preferably one of the t-norms described above. At step 206, each of the aggregation values for each of the classes is compared in the highest aggregation value as selected. At step 208, the possibility and belief messages are calculated for the class associated with the selected aggregation value. Possibility values are calculated by dividing a particular aggregation value associated with a particular class by the highest of the aggregation values which were selected at step 206. The belief measures calculated by subtracting the possibility value for the particular class from the next highest possibility value. Because the class corresponding to the highest aggregation value at step 204 will always result in a possibility of one, the belief measure for the selected class reduces to (1−α) where α is the second highest possibility value. At step 10, the belief or truth for the hypothesis that the particular instance belongs to the class selected by the highest possibility value is output on the display 104.

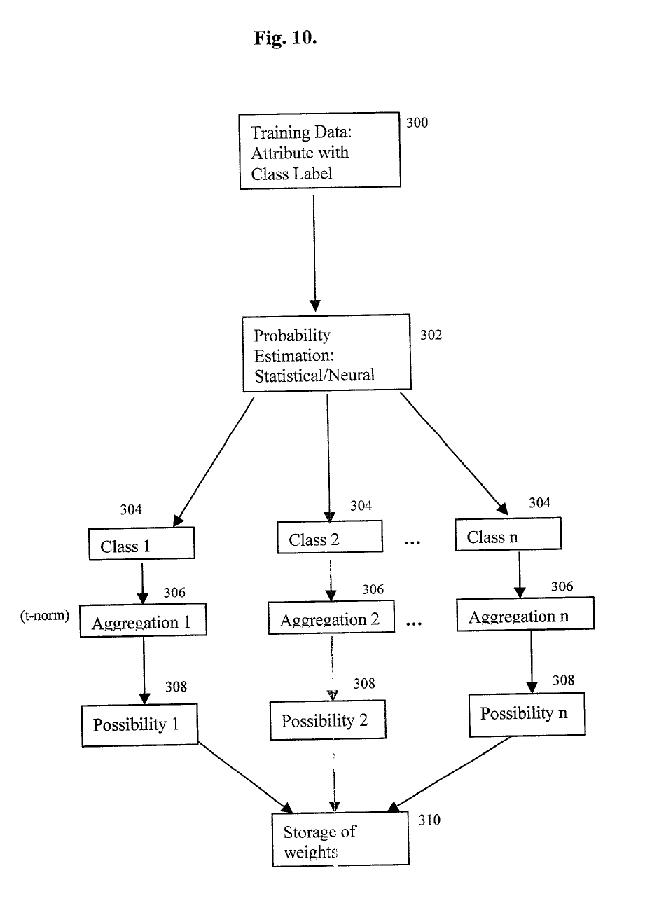

FIG. 10 illustrates a preferred method of supervised learning according to the present invention. At step 300 training data is received from the data base 112. The training data includes a plurality of attribute values, as well as a class label for each record. At step 302, probability estimation is performed for each record of the training data. At step 304, the attribute data for each record is passed one at the time on for testing the hypothesis that the particular record belongs to each of the possible classes. At step 306, for each of the classes the attribute data is aggregated using a selected t-norm function. At step 308, the aggregated value of the attributes is converted into possibility values. Finally, at step 310, for each record processed the weights attributed to each attribute are updated according to how much information useful in classifying was obtained form each attribute. For each record of the training data the classification resolved by the machine is compared to the available class label and the weights are increased where the correct classification was made, and decreased where faulty classification occurred. In this matter, by appropriately adjusting the weights to be attributed to each attribute, the machine is capable of learning to classify future data which will not have the class label available.

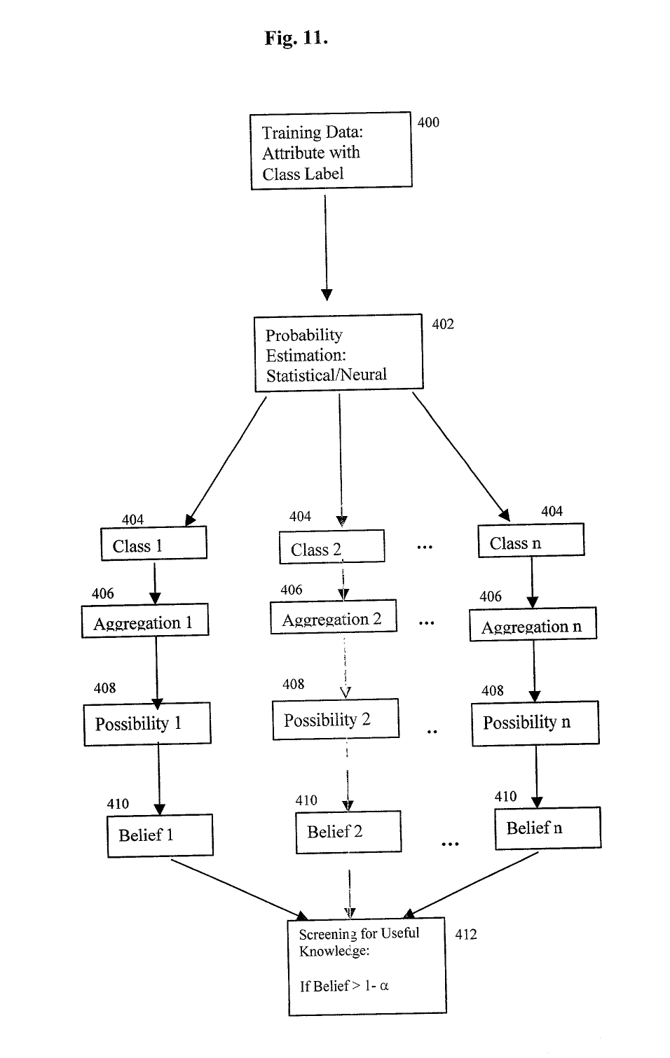

FIG. 11 illustrates the preferred method of knowledge discovery using the present invention. At step 400 training data is retrieved from the data base 112. Probability estimation is performed at step 402. At step 404, each of the records is tested for each of the classes. At step 406, the attributes are aggregated for each of the classes according to the selected t-norm function. At step 408, the aggregated values are converted into possibilities. At step 410, belief values are calculated from the possibilities generated in step 408. Finally, in step 412, the belief values are screened for each of the classes with the highest beliefs corresponding to useful knowledge. Thus, using the method illustrated in FIG. 11, the most useful attributes can be identified. Thus, in subsequent classifications computation overload can be reduced by eliminating the last use for attributes form processing.

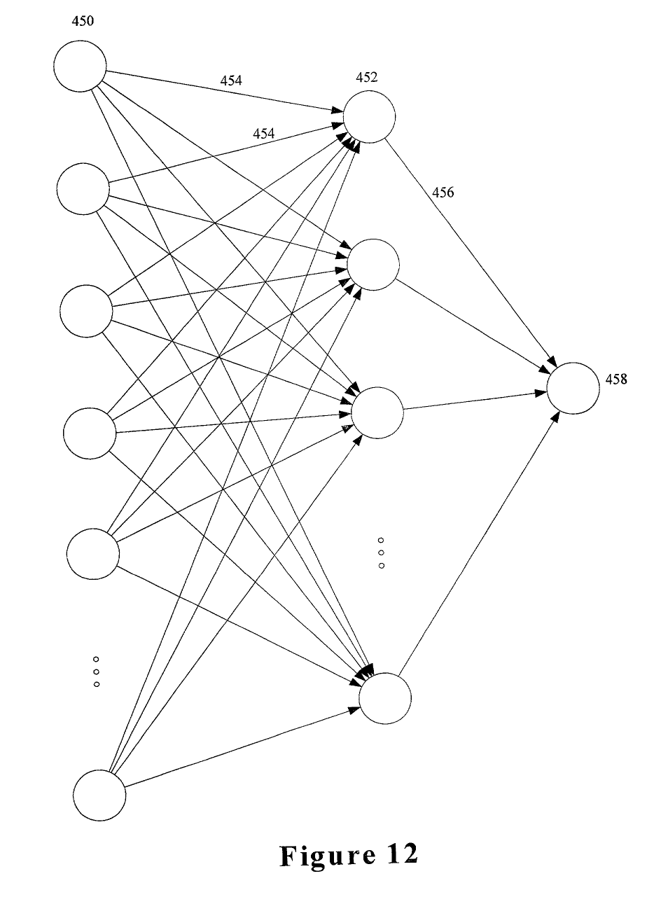

FIG. 12 illustrates a neural network according to the present invention. The neural network comprises a plurality of input nodes 450. The input nodes 450 are connected to each of the plurality of output nodes 452 by connectors 454. Each of the output nodes 452 in turn produces a output 456 which is received by the confidence factor node 458.

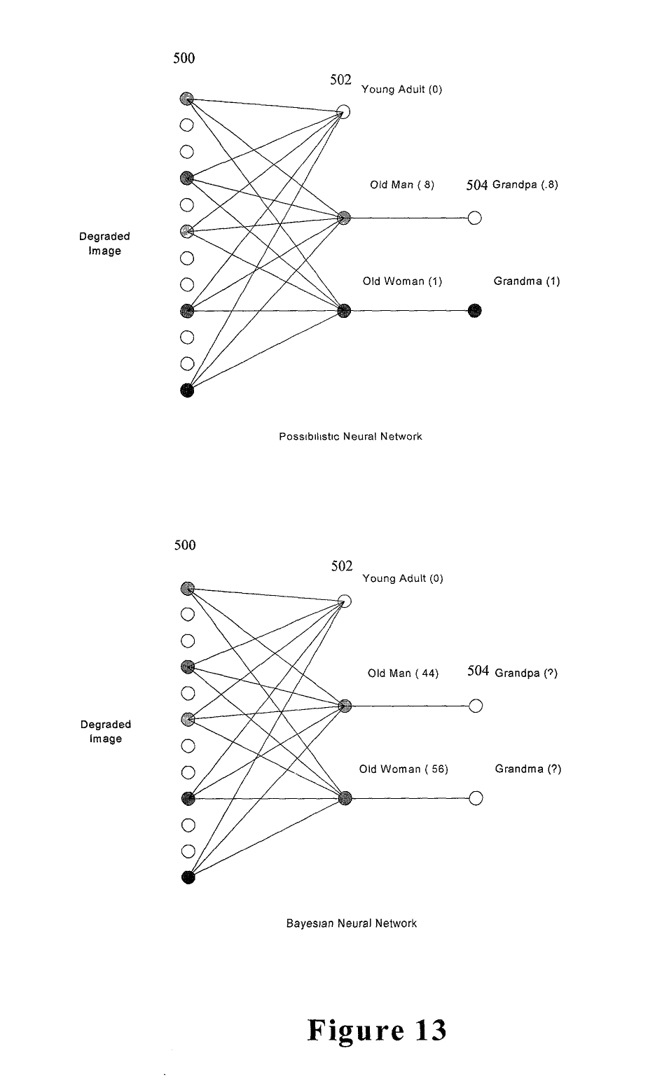

FIG. 13 illustrates a Bayesian neural network which performs probabilistic computations, and compares it against a possibilistic neural network according to the present invention. Both neural networks have a plurality of input ports 500 as well as an intermediate layer of ports 502. The output of an intermediate layer is calculated differently in a possibilistic network as compared to the Bayesian neural network. As shown in the Bayesian neural network, the output of the intermediate layer nodes 502 is probabilistic, therefore it sums to 1. However, in the possibilistic network the most possible choice, old woman, is give an value of 1, more, while the next highest value, old man, is give the comparatively lower value (0.8). Therefore, the possibilistic neural network would classify the degraded input image as grandma, however the belief that the grandma classification is correct would be relatively low because the upper value for grandpa is not significantly lower than the upper value for grandma. This is also shown in the Bayesian neural network. However, as will be seen if further information became available, the additional attributes would be more easily assimilated into the possibilistic neural network than it would in the Bayesian neural network. If additional attributes are made available in the possibilistic neural network, the new information is simply added to the existing information, resulting in updated possibility outputs. In the Bayesian network, by contrast, in order to incorporate new information, each of the probabilistic outputs will have to be recomputed so that the probabilistic outputs once again sum to 1. Thus, the possibilistic network is at least as effective in classifying as the Bayesian neural network is, with the added benefits of a confidence factor, and lower computational costs.

While advantageous embodiments have been chosen to illustrate the invention, it will be understood by those skilled in the art that various changes and modifications can be made therein without departing from the scope of the invention.

What is claimed is:

1. A method of classifying a thing as a member of one or more out of a plurality of classes, said thing having a plurality of attributes associated therewith, said method comprising the steps of:
(a) for each of said plurality of classes, assigning attribute values based on each of said attributes, each said attribute value representative of a relative possibility that said thing is a member of the associated class based on said attribute,
(b) for each of said plurality of classes, aggregating said attribute values using a t-norm function,
(c) selecting a highest aggregated value,
(d) determining that said thing belongs to the class associated with said highest aggregated value, and
(e) determining a confidence factor based on the relative magnitude of said highest aggregated value and a second highest aggregated value.

2. The method of claim 1 further comprising:
(f) normalizing said attribute values based on the relative information provided by each attribute.

3. A method of training a machine to classify a thing as a member of one or more out of a plurality of classes, the method comprising the steps of:
(a) providing training data to said machine, said training data comprising a plurality of records, each record having attribute data associated therewith, said attribute data comprising values associated with a plurality of possible attributes, each record further having a class value associated therewith indicating the class to which the record belongs,
(b) for each of said possible attributes, normalizing said attribute data for each record based on the distribution of values present for the attribute in substantially all of said records,
(c) for each of said records, performing a t-norm operation on the available attribute data, and generating a possibility value for each of said possible classes, said possibility values corresponding to the relative possibility that the record belongs to one of said particular classes,
(d) for each of said plurality of classes, aggregating substantially all of the records having the class value associated with said class, and generating weights for each of the attributes according to the degree that each attribute corresponds with a correct determination of said class.

4. The method of claim 3, further comprising the steps of:
(e) for each of said records, generating belief values for the one or more classes having the highest possibility values, said belief value representing the difference between the possibility value for said class, and the next highest possibility value, and
(f) generating a list of informative attributes from the attributes associated with records for which belief values above a threshold value were generated.

5. An article of manufacture adapted to be used by a computer, comprising:
a memory medium on which are stored machine instructions that implement a plurality of functions useful for classifying an item as a member of one or more out of a plurality of classes, said thing having a plurality of attributes associated therewith, when the machine instructions are executed by a computer, said functions including:
(a) for each of said plurality of classes, assigning attribute values based on each of said attributes, each said attribute value representative of a relative probability that said thing is a member of the associated class based on said attribute,
(b) for each of said plurality of classes, aggregating said attribute values using a t-norm function,
(c) selecting a highest aggregated value,
(d) determining that said thing belongs to the class associated with said highest aggregated value, and
(e) determining a confidence factor based on the relative magnitude of said highest aggregated value and a second highest aggregated value.

6. An article of manufacture adapted to be used by a computer, comprising:
a memory medium on which are stored machine instructions that implement a plurality of functions useful for training a machine to classify a thing as a member of one or more out of a plurality of classes, said functions including:
(a) providing training data to said computer, said training data comprising a plurality of records, each record having attribute data associated therewith, said attribute data comprising values associated with a plurality of possible attributes, each record further having a class value associated therewith indicating the class to which the record belongs,
(b) for each of said possible attributes, normalizing said attribute data for each record based on the distribution of values present for the attribute in substantially all of said records,
(c) for each of said records, performing a t-norm operation on the available attribute data, and generating a possibility value for each of said possible classes, said possibility values corresponding to the relative possibility that the record belongs to one of said particular classes,
(d) for each of said plurality of classes, aggregating substantially all of the records having the class value associated with said class, and generating weights for each of the attributes according to the degree that each attribute corresponds with a correct determination of said class.

7. The article of claim 6, said functions further including:
(e) for each of said records, generating belief values for the one or more classes having the highest possibility values, said belief value representing the difference between the possibility value for said class, and the next highest possibility value, and
(f) generating a list of informative attributes from the attributes associated with records for which belief values above a threshold value were generated.

8. An apparatus adapted to classify a thing as a member of one or more out of a plurality of classes, said thing having a plurality of attributes associated therewith, said apparatus comprising:
an output device and an input device,
a processor, and
a memory having machine executable instructions for performing a series of functions stored therein, and adapted to receive and store a series of data records, said functions including:
(a) receiving at said input device a data record corresponding to said thing sought to be classified, said data record comprising attribute values corresponding to the attributes of said thing,
(b) for each of said plurality of classes, generating an aggregated value by aggregating said attribute values using a t-norm function,
(c) selecting a highest aggregated value from said aggregated values,
(d) determining a most possible class from among the plurality of classes based on said highest aggregated value,
(e) determining a confidence factor based on the relative magnitude of said highest aggregated value and a second highest aggregated value, and
(f) outputting said most possible class and said confidence factor at said output device.

9. An apparatus adapted to be trained to classify a thing as a member of one or more out of a plurality of classes, said thing having a plurality of attributes associated therewith, said machine comprising:
an output device and an input device,
a processor, and
a memory having machine executable instructions for performing a series of functions stored therein, and adapted to receive and store a series of data records, said functions including:
(a) receiving training data at said input device, said training data comprising a plurality of records, each record having attribute data associated therewith, said attribute data comprising values associated with a plurality of attributes, each record further having a class value associated therewith indicating the class to which the record belongs,
(b) for each of said attributes, normalizing said attribute data for each record based on the distribution of values present for the attribute in substantially all of said records,
(c) for each of said records, performing a t-norm operation on the available attribute data, and generating a possibility value for each of said possible classes, said possibility values corresponding to the relative possibility that the record belongs to one of said particular classes,
(d) for each of said plurality of classes, aggregating substantially all of the records having the class value associated with said class, and generating weights for each of the attributes according to the degree that each attribute corresponds with a correct determination of said class.

10. The apparatus of claim 9, said functions further comprising:
(e) for each of said records, generating belief values for the one or more classes having the highest possibility values, said belief value representing the difference between the possibility value for said class, and the next highest possibility value, and
(f) generating a list of informative attributes from the attributes associated with records for which belief values above a threshold value were generated.

11. The apparatus of claim 10, said functions further comprising:
(g) outputting said belief values and said list through said output device.

12. A neural network comprising:
at least an input layer and an output layer, the input layer having a plurality of input nodes, and the output layer having a plurality of output nodes, such that each of the output nodes receives weighted input from each of the input nodes representative of the possibility that the particular output node represents the correct output,
wherein the output nodes aggregate the input from each of the input nodes according to a t-norm function, and produce an output representative of the result of the t-norm function.

13. A neural network comprising:
at least an input layer, an output layer, and at least one confidence factor node, the input layer having a plurality of input nodes, and the output layer having a plurality of output nodes, such that each of the output nodes receives weighted input from each of the input nodes representative of the possibility that the particular output node represents the correct output, and the confidence factor node receives input from each of the output nodes,
wherein the output nodes aggregate the input from each of the input nodes according to a t-norm function, and produce an output representative of the result of the t-norm function, and wherein the confidence factor node produces an output representative of the difference between the highest output from the output nodes and the second highest output from the output nodes.

14. The neural network of claim 13 wherein the network includes a plurality of confidence factor nodes, each receiving input from each of the output nodes, and the output of each confidence factor node is representative of the difference between the output of the n highest output nodes and the next highest output from the output nodes.

15. A universal parallel distributed computation machine comprising:
at least an input layer and an output layer, said input layer having a plurality of input neurons, and said output layer having a plurality of output neurons, such that each of said neurons has a weight connection to at least one other neuron,
wherein said weight connection represents mutual information, and said mutual information is represented by a likelihood function of weight.

16. The machine of claim 15 wherein a value for said weight connections is determined by multiplying the likelihood functions for two associated neurons, and normalizing the result.

17. The machine of claim 15 wherein said machine is an analog parallel distributed machine.

18. The machine of claim 15 wherein said machine is a digital parallel distributed machine.

19. The machine of claim 15 wherein said machine is a hybrid digital and analog parallel distributed machine.

20. A method of training a neural network comprising an input layer having a plurality of input neurons and an output layer having a plurality of output neurons, each of said neurons having a weight connection to at least one other neuron, said method comprising the steps of:
(a) providing training data to said machine, said training data comprising a plurality of records, each record having at least one neuron associated therewith, such that said record causes said associated neuron to fire a signal to connected neurons,
(b) updating weights of said weight connections using a likelihood rule, said rule based on the likelihood of each connected neuron firing and of both neurons firing together,
(c) aggregating said signals at each said connected neuron with a t-conorm operation,
(d) evaluating the performance of said machine, and
(e) repeating steps (a)-(d).
